(19) United States
(12) Patent Application Publication
(10) Pub. No.: US 2006/0185209 A1
(43) Pub. Date: Aug. 24, 2006

(54) CARPET MAT NAME BADGE WITH GRIPPING DEVICE

(75) Inventors: Robert W. Donaldson, Eureka, MO (US); Aaron Kristopher Berendt, Milford, MI (US)

Correspondence Address: BLACKWELL SANDERS PEPER MARTIN LLP, 720 OLIVE STREET, SUITE 2400, ST. LOUIS, MO, 63101, US

(73) Assignee: SIEGEL-ROBERT, INC., St. Louis, MO (US)

(21) Appl. No.: 10/906,517

(22) Filed: Feb. 23, 2005

(51) Int. Cl. G09F 3/12

(52) U.S. Cl. 40/668

(57) ABSTRACT

A carpet mat nameplate/gripping device comprising a bezel cap plate portion having an area recessed below a facing surface for receiving an insert plate, a protuberant short stud boss extending from the opposing side of the bezel cap plate, a base retainer plate portion having a hole pattern extending therethrough for receiving the protuberant short stud boss and said base retainer plate portion further having a plurality of anti-slip carpet hooks extending from a face of the base plate to form a snag having a beveled pointed end and said hook positioned in a symmetrical pattern about a central area of the face of the base plate and such that the pointed ends of each hook are directed radially away from the central area, which teaches a novel nameplate and anti-slip device for floor mats.

### BACKGROUND OF INVENTION

1. Field of Invention

This invention relates generally to mats for covering and protecting carpets and, more particularly, to name badges and carpet gripping devices for carpet mats such as mats for automotive floor carpet.

2. Background Art

Floor mats are commonly used on the floor of automobiles to keep clean and reduce the wear on the floor carpets of automobiles. Floor mats are also commonly used in other carpeted areas such as homes or apartments. Floor mats are made of various materials including rubber and carpet material or a combination thereof.

Floor mats displaying colorful insignias such as that of a car manufacturer are commonly used for automobile floor mats. The insignias are sometimes embroidered patches or rubber/plastic stamps or badges. There are also insignias created by bonding thermoplastic resins to the mat. Each of these types of insignias or badges suffer from premature wear and tear problems. The rubbing action from shoes of the driver and passenger against the insignia tends to wear out the insignias causing an unattractive appearance. A badge or insignia design is needed that suffers from less wear and tear.

Floor mats also have the tendency to shift and slide around on the carpet surface that it is covering. This can be annoying because the mat has to be continuously repositioned to its original desired position. This is particularly true for the floor mats of an automobile, which have the tendency to shift around due to repeated action of drivers and passengers getting into and out of an automobile. Floor mats positioned in other high traffic areas such as hallways in homes experience a similar problem.

Various types of carpet gripping devices have been utilized to affix a floor mat in particular position. For example common gripping devices including a flat base member with a plurality of prongs extending therefrom which are affixed to the underside of a mat have been commonly utilized. In many cases these prongs are angled to provide a greater gripping action. However, many of these devices are easily detached through wear and tear from the underside of the mat. Also, many of the designs, though they have angled prongs for improved gripping action, require special placement about the underside of the mat such that the gripping action or direction of each of the devices compliments the others so that the mat is prevented from moving in any direction. A gripping device is needed that is more durable and that does not require special placement of a plurality of the devices about the underside of the map in order to restrict movement of the mat in all directions.

### BRIEF SUMMARY OF INVENTION

The invention is a name plate badge with an anti-slip feature for a floor mat, particularly for an automobile floor mat. The invention combines name plate badge features with anti-slip gripping device features to resolve the problems noted above related to common name plate and gripping device designs.

The invention is a carpet mat name badge and gripping device comprising a bezel cap plate portion having a facing area recessed inward from a facing surface for receiving an insert plate and said recessed area having an inward depth from the facing surface sufficient for the insert plate to be recessed below the facing surface when installed in the recessed area. The insert plate is subject to less wear and tear because it is recessed such that it avoids contact, with passenger and driver shoes as they get into and out of the automobile. The plate can further have a protuberant short stud boss extending from the opposing side of the bezel cap plate for mounting on a base plate.

The invention also includes a base retainer plate portion having a through hole extending therethrough such that the protuberant short stud boss can be received therethrough for affixing the bezel cap plate portion to the base retainer plate portion.

The floor mat is pressed between the base retainer plate and the bezel cap plate. The floor mat can have a hole for receiving the stud boss there through. The base retainer plate portion further includes a plurality of anti-slip carpet hooks extending from a face of the base plate to form a snag each having a beveled pointed end and said hooks positioned in a symmetrical pattern about a central area of the face of the base plate and such that the pointed ends of each hook are directed radially away from the central area. The direction of the hook or hooking action of each hook is radially directed away from a common central area such that the hooks compliment each other to resist movement of a mat in all directions. A single base plate resists movement in all directions rather than requiring a special complimentary positioning of multiple gripping devices each having angled prongs or hooks such that movement of a mat is resisted in all directions.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a top isometric breakout view of the decorative insert plate or nameplate/badge, the bezel cap plate portion and the base retainer plate portion;

FIG. 2 is a bottom isometric breakout view of the base retainer plate portion, the bezel cap plate portion and the decorative nameplate/badge;

FIG. 3 is a side/bottom isometric view of the bezel cap plate portion installed on the base retainer plate portion;

FIG. 4 is a top/side isometric view of the nameplate installed on the bezel and the bezel installed on the base retainer plate; and

FIGS. 5 and 5A is a top isometric breakout view of an alternative embodiment of the insert plate, bezel cap plate portion and base retainer plate.

### DETAILED DESCRIPTION OF INVENTION

According to the embodiment(s) of the present invention, various views are illustrated in FIG. 1-5A and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a bezel cap plate portion having a facing area recessed below a facing surface for receiving an insert plate, a protuberant short stud boss extending from the opposing side of the bezel cap plate, a base retainer plate portion having a hole pattern extending therethrough for receiving the protuberant short stud boss and said base retainer plate portion further having a plurality of anti-slip carpet hooks extending from a face of the base plate to form a snag each having a beveled pointed end and said hook positioned in a symmetrical pattern about a central area of the face of the base plate and such that the pointed ends of each hook are directed (direction of hooking action) radially away from the central area, which teaches a novel nameplate and anti-slip device for floor mats. An alternative embodiment further comprises a bezel cap plate having a pair of stud bosses and a pair of through holes in the base plate for receiving them. Yet another embodiment comprises a second set of carpet hooks extending from the face of the base plate and positioned along the perimeter. Each carpet hook in the second set are oriented such that the hooking action of each carpet hook is complimentary (hooking action in a substantially opposing direction) to at least one of the carpet hook in the second set.

The details of the invention and various embodiments can be better understood by referring to the figures of the drawing. Referring to FIG. 1, an isometric breakout view of the badge/anti-slip device 100 is shown including a decorative insert plate or name plate badge 102, a bezel cap plate portion 104, and a base retainer plate portion 106. The bezel cap plate portion 104 is shown having an inwardly recessed facing area 107 for receiving the name plate 102. A recessed facing area 107 is recessed below a facing surface 108 of the bezel cap plate. The recessed facing area has sufficient depth such that it allows the name plate to be recessed below the facing surface of the bezel cap plate when the name plate is installed such that the name plate avoids contact and wear and tear. On the opposing side of the bezel, a short protuberant stub boss 110 is shown extending from the underside of the bezel. The base retainer plate 106 is shown with a through hole 112 for receiving the stud boss 110 therethrough for affixing the cap to the base. The stud boss can be press fit in place or the stud boss can be formed or melted over the through hole 112 by a heating process.

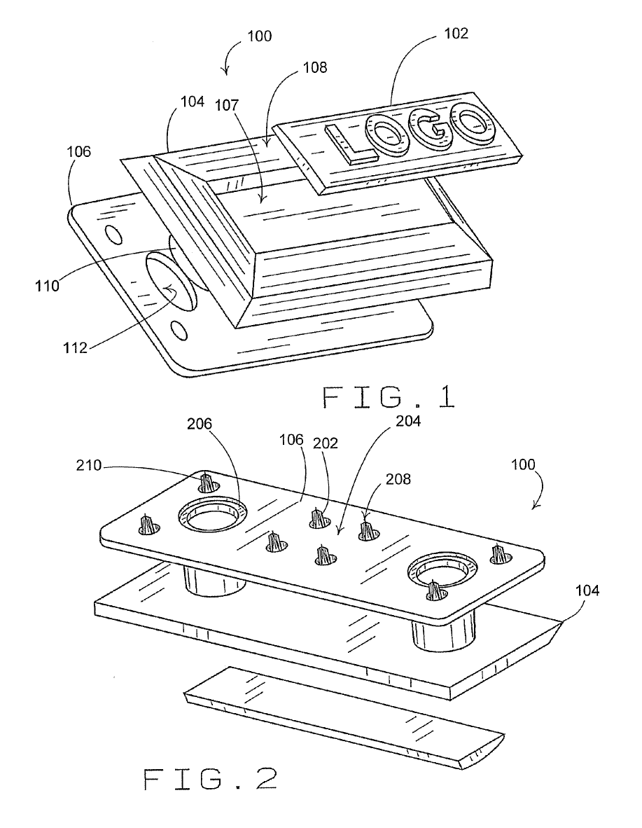

Referring to FIG. 2, a bottom isometric breakout view of the device 100 is shown. A bottom view of the base retainer plate 106, bezel 104, and name plate 102 is shown. The bottom view of the base retainer plate 106 reveals that the through hole 112 for receiving the stud boss 110, has a recessed counter bore 206 which provides an area for the material of the boss to be formed over by heating or other mechanically-assigned staking operation. The stud boss also reveals a pair of through holes in the base plate for receiving a pair of stud bosses.

The bottom view of the base retainer plate also reveals the plurality of hooks 202, extending from the underside of the base retainer plate to form a snag and having a beveled pointed end 208. The hooks 202 can be positioned around a central portion 204 of the base retainer plate, as shown, such that the pointed ends 208 (or the direction of the hooking actions of the hooks) are directed radially away from the center portion, 204. This orientation of the hooks provides a plurality of complimentary hooking actions among the hooks 202 such that movement is resisted in all directions.

Further, second set of other hooks 21 0 can be positioned around the perimeter such that their orientation directs the point or hooking action radially away from a central area, such as the center of the through hole 112. However, preferably, the hooking action of the perimeter hooks can be directed to compliment each other such that all directions of movement of a mat is restricted. This hook pattern allows a single base retainer plate to restrict movement in all directions. Therefore, a given base plate's position on a floor mat is not driven by a requirement to compliment the position of another base plate for controlling or restricting slippage in all directions. This design allows a single base plate to restrict movement of the mat in all directions.

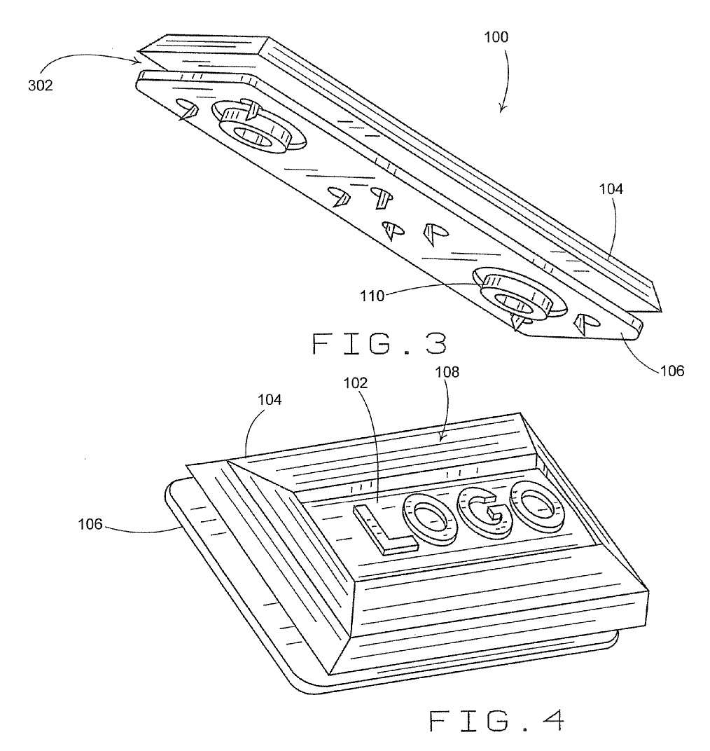

Referring to FIG. 3, a side isometric view of the name plate/gripping device 100 is shown. The bezel 104 is shown installed on the base retainer plate 106 such that the stud bosses 110 extend through the through hole of the base retainer plate. The anti-slip hooks are also shown, which further illustrates that the hook pattern layout will restrict movement of a mat in all directions. A given mat (not shown), is pressed between the bezel and the base retainer plate in the area therebetween 302. The mat is pressed between the bezel and the base plate of the device 100 and fixed in place by forming the stud boss over the through hole in the recessed counter bore area. The mat will have a set of holes for receiving the stud bosses there through. The device 100 is thereby fixed in place on the mat and is ready for usage.

Referring to FIG. 4, a top/side isometric view of the name plate installed on the bezel and the bezel installed on the base retainer plate is shown. The bezel 104 would be installed or pressed through the top portion of the mat and the base retainer plate 106 would be pressed from the underside of the mat thereby containing the mat therebetween. The name plate or insert plate 102 is shown installed in the recessed area of the bezel 104. The name plate 102 is shown recessed below the bezel facing surface 108. This recession of the name plate prevents scuffing and rubbing action from shoes and the like during normal wear and tear. The recessed design of the name plate increases the longevity of the appearance of the insignia or logo placed on the name plate 102.

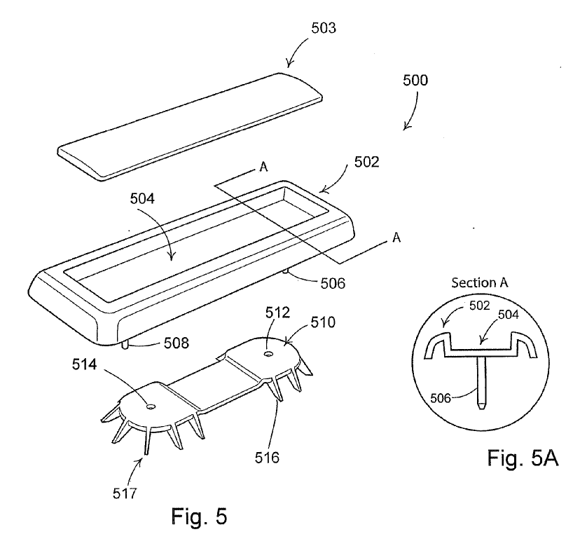

Referring to FIGS. 5 and 5A a top/side isometric view of an alternative embodiment is shown. A carpet mat name badge and gripping device 500 is shown comprising a base retaining plate portion 510 for mounting the bezel 502 having a through hole 512 and 514 extending from a top side through to a bottom side of the base plate for receiving and mounting a stud boss 508 and 506 of a name plate.

The base retaining plate portion 510 has a first set of hooks 516 extending from the bottom side of the base plate to form a snag and each hook in the first set of hooks having beveled pointed ends and positioned about a perimeter of a first end of said base retaining plate and said first set of hooks are symmetrically arranged about the perimeter of the first end and said beveled pointed ends of the first set of hooks are directed radially away from the first end of the base plate. The base retaining plate portion further has a second set of hooks 517 extending from the bottom side to form a snag and each hook in the second set of hooks has beveled pointed ends and positioned about a perimeter of an opposing end opposite the first end of said base plate and said second set of hooks are symmetrically arranged about the perimeter of the opposing end and said beveled pointed ends of the second set of hooks are directed radially away from the opposing end of the base plate.

A decorative insert plate or name plate badge 503 is shown, with a bezel cap plate portion 502 for mounting on the base retainer plate portion 510. The bezel cap plate portion 502 is shown having an inwardly recessed facing area 504 for receiving the name plate 503. A recessed facing area 504 is recessed below a facing surface of the bezel cap plate. The recessed facing area has sufficient depth such that it allows the name plate to be recessed below the facing surface of the bezel cap plate when the name plate is installed such that the name plate avoids contact and wear and tear. On the opposing side of the bezel, short protuberant stub bosses 506 and 508 are shown extending from the underside of the bezel. The base retainer plate 510 is shown with through holes 512 and 514 for receiving the stud bosses there through for affixing the cap to the base. The stud boss can be press fit in place, or fixed in place by heat staking or orbital forming or the stud boss can be formed or melted over the through hole by a heating process. FIG. 5A shows a cross section of the bezel cap plate portion 502 revealing the recessed facing area 504 and the stud boss 506.

The various embodiments of the carpet mat badge and gripping device examples shown above illustrate a novel invention for a carpet mat nameplate holder with anti-slip feature. A user of the present invention may choose any of the above badge embodiments, or an equivalent thereof, depending upon the desired application. In this regard, it is recognized that various forms of the subject carpet mat badge invention could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A carpet mat name badge and gripping device comprising:
a bezel cap plate portion having an inwardly recessed facing area recessed inward from a facing surface of the bezel cap plate portion for receiving an insert plate and said recessed facing area having a recessed depth sufficient for the insert plate to be recessed below the facing surface of the bezel cap plate when installed in the recessed facing area and said bezel cap plate further having a protuberant stud boss extending from a side opposite the facing surface of the bezel cap plate; and
a base retainer plate portion having a through hole extending therethrough such that the protuberant short stud boss can be received therethrough for affixing the bezel cap plate portion to the base retainer plate portion and said base retainer plate portion further having a plurality of anti-slip carpet hooks extending from a face of the base plate to form a plurality of snags and having beveled pointed ends and said hooks positioned in a complimentary symmetrical pattern about a central area of the face of the base plate and such that the pointed ends of each hook are directed radially away from the central area for hooking actions that resists movement in all directions.

2. The device as recited in claim 1, where the insert plate is a nameplate.

3. The device as recited in claim 1, where the through hole has a counter bore recessed area for forming the stud boss thereover to affix the bezel cap plate.

4. A carpet gripping device comprising:
a base retaining plate having a through hole extending from a top side through to a bottom side where said through hole has a recessed counter bore on the bottom side of the through hole for receiving and mounting a stud boss of a name plate,
said base retaining plate having a central area and a first set of anti-slip carpet hooks extending from the bottom side to form a snag and having a beveled pointed end and said hooks symmetrically arranged about the central area each having said beveled pointed ends directed radially away from said central area, and
said base retaining plate having a second set of hooks extending from the bottom side and positioned about the perimeter of the base plate and oriented in a pattern such that each hook in the second set compliments at least one other hook in the second set thereby resisting slipping in all directions.

5. A carpet mat name badge and gripping device comprising:
a bezel cap plate portion having a nameplate on a facing side and said bezel cap plate further having a protuberant short stud boss extending from the opposing side of the bezel cap plate; and
a base retainer plate portion having a hole extending therethrough such that the protuberant short stud boss can be received therethrough for affixing the bezel cap plate portion to the base retainer plate portion and said base retainer plate portion further having a plurality of anti-slip carpet hooks extending from a face of the base plate to form a plurality of snags and having beveled pointed ends and said hooks positioned in a complimentary symmetrical pattern about a central area of the face of the base plate and such that the pointed ends of each hook are directed radially away from the central area for hooking actions that resists movement in all directions.

6. A carpet mat name bade and gripping device comprising:
a base retaining plate portion having a through hole extending from a top side through to a bottom side for receiving and mounting a stud boss of a name plate;
said base retaining plate portion having a first set of hooks extending from the bottom side to form a first snag and each hook in the first set of hooks having beveled pointed ends and positioned about a perimeter of a first end of said base retaining plate and said first set of hooks symmetrically arranged about the perimeter of the first end and said beveled pointed ends of the first set of hooks directed radially away from the first end of the base plate; and
said base retaining plate portion further having a second set of hooks extending from the bottom side to form a second snag and each hook in the second set of hooks having beveled pointed ends and positioned about a perimeter of an opposing end opposite the first end of said base plate and said second set of hooks symmetrically arranged about the perimeter of the opposing end and said beveled pointed ends of the second set of hooks directed radially away from the opposing end of the base plate.

7. A carpet mat name bade and gripping device comprising:
a bezel cap plate portion having an inwardly recessed facing area recessed inward from a facing surface of the bezel cap plate portion for receiving an insert plate and said recessed facing area having a recessed depth sufficient for the insert plate to be recessed below the facing surface of the bezel cap plate when installed in the recessed facing area and said bezel cap plate further having a protuberant stud boss extending from a side opposite the facing surface of the bezel cap plate;
a base retaining plate portion having a through hole extending from a top side through to a bottom side for receiving and mounting the protuberant stud boss of the bezel cap plate portion;
said base retaining plate portion having a first set of hooks extending from the bottom side to form a first snag and each hook in the first set of hooks having beveled pointed ends and positioned about a perimeter of a first end of said base retaining plate and said first set of hooks symmetrically arranged about the perimeter of the first end and said beveled pointed ends of the first set of hooks directed radially away from the first end of the base plate; and
said base retaining plate portion further having a second set of hooks extending from the bottom side to form a second snag and each hook in the second set of hooks having beveled pointed ends and positioned about a perimeter of an opposing end opposite the first end of said base plate and said second set of hooks symmetrically arranged about the perimeter of the opposing end said and said beveled pointed ends of the second set of hooks directed radially away from the opposing end of the base plate.
